(19) United States
(12) Patent Application Publication
(10) Pub. No.: US 2010/0157478 A1
(43) Pub. Date: Jun. 24, 2010

(54) SYSTEM AND METHOD FOR STORAGE OF DIGITAL ASSETS

(75) Inventors: Craig N. Changstrom, Loveland, CO (US); John Main, Fort Collins, CO (US); David H. Hanes, Loveland, CO (US)

Correspondence Address: HEWLETT-PACKARD COMPANY;Intellectual Property Administration, 3404 E. Harmony Road, Mail Stop 35, FORT COLLINS, CO, 80528, US

(73) Assignee: HEWLETT-PACKARD DEVELOPMENT COMPANY, L.P., Houston, TX (US)

(21) Appl. No.: 12/338,735

(22) Filed: Dec. 18, 2008

(51) Int. Cl. G11B 5/74; G06F 13/00; G06F 12/14

(52) U.S. Cl. 360/131; 711/103; 726/21; 711/E12.001; G9B/5.289

(57) ABSTRACT

A storage apparatus is provided. A storage apparatus can include a storage device having one or more unique device identifiers disposed in, on, or about the storage apparatus. One or more computer readable and writeable data storage areas can be disposed in, on, or about the storage apparatus. One or more computer readable data storage areas can also be disposed in, on, or about the storage apparatus. One or more computer readable instruction sets can be disposed in, on, or about the storage apparatus. The execution of all or a portion of the one or more computer readable instruction sets can be contingent upon the successful authentication of all or a portion of the one or more device identifiers.

### BACKGROUND OF THE INVENTION

1. Field of the Invention

Embodiments of the present invention generally relate to systems and methods of digital data management. More particularly, embodiments of the present invention relate to systems and methods for secure data backup.

2. Description of the Related Art

Digital content, in the form of data files containing applications, documents, presentations, photos, movies and music, enjoys both widespread availability and widespread acceptance. The resultant music, photo, and video files often encompass multiple file types which are frequently scattered across one or more storage devices connected to a single computer system. With the advent of inexpensive, readily available, high-capacity, storage devices, the size and number of stored music, photo, and video files continues to increase with time.

Periodic back-up of stored digital data is important to both preserve the integrity of the data and to guard against loss or corruption. Currently, computer users employ a variety of mechanisms, technologies, and techniques to copy, back-up, or archive data files. Examples include manually making a duplicate copy of data files on separate storage medium or using a dedicated backup application and/or online or network service to execute more intricate, elaborate, or comprehensive backup schemes. However, manual copying of files can be quite cumbersome and using backup software can require confusing configuration steps. Additionally, the backup software itself is always susceptible to piracy unless an effective means to ensure that only licensed copies of the software and data storage medium are used to perform the backup.

### SUMMARY OF THE INVENTION

So that the manner in which the above recited features of the present invention can be understood in detail, a more particular description of the invention, briefly summarized above, may be had by reference to embodiments, some of which are illustrated in the appended drawings. It is to be noted, however, that the appended drawings illustrate only typical embodiments of this invention and are therefore not to be considered limiting of its scope, for the invention may admit to other equally effective embodiments.

A storage apparatus is provided. A storage apparatus can include a storage device having one or more unique device identifiers disposed in, on, or about the storage apparatus. One or more computer readable and writeable data storage areas can be disposed in, on, or about the storage apparatus. One or more computer readable data storage areas can also be disposed in, on, or about the storage apparatus. One or more computer readable instruction sets can be disposed in, on, or about the storage apparatus. The execution of all or a portion of the one or more computer readable instruction sets can be contingent upon the successful authentication and/or validation of all or a portion of the one or more device identifiers.

A method for storing data is also provided. A storage apparatus can be communicatively coupled to a computer. The storage apparatus can include, but is not limited to: one or more storage devices; one or more unique device identifiers identifying the storage device; one or more computer readable and writeable data storage areas; one or more computer readable data storage areas; and one or more computer readable instruction sets. The unique device identifier disposed in, on, or about the storage apparatus can be read and authenticated by the computer. All or a portion of the computer readable instruction set can be executed contingent upon the authentication and/or validation of all or a portion of the one or more unique device identifiers. The computer can transfer one or more files and/or data from one or more storage devices disposed in, on, or about the computer to the one or more computer readable and writeable data storage areas of the storage apparatus in response to all or a portion of the computer readable instruction set.

A system for storage of digital data is also provided. The system can include a means for disposing a storage apparatus in, on, or about a computer. The storage apparatus can include: one or more storage devices; one or more unique device identifiers indentifying the storage device; one or more computer readable and writeable data storage areas; and one or more computer readable instruction sets, wherein the execution of all or a portion of the one or more instruction sets is contingent upon the successful authentication and/or validation of all or a portion of the one or more unique device identifiers. The system can include a means for reading the one or more unique device identifiers disposed in, on, or about the storage apparatus. The system can include a means for authenticating and/or validating the storage apparatus using the one or more unique identifiers, and a means for transferring data from the computer to all or a portion of the one or more computer readable and writeable data storage areas.

### BRIEF DESCRIPTION OF THE DRAWINGS

So that the manner in which the above recited features of the present invention can be understood in detail, a more particular description of the invention, briefly summarized above, may be had by reference to embodiments, some of which are illustrated in the appended drawings. It is to be noted, however, that the appended drawings illustrate only typical embodiments of this invention and are therefore not to be considered limiting of its scope, for the invention may admit to other equally effective embodiments.

Advantages of one or more disclosed embodiments may become apparent upon reading the following detailed description and upon reference to the drawings in which:

FIG. 1 depicts an exemplary storage apparatus for the storage of one or more digital assets, according to one or more embodiments described herein;

FIG. 2 depicts an exemplary optical storage medium for the storage of one or more digital assets, according to one or more embodiments described herein;

FIG. 3 depicts an exemplary semiconductor storage medium for the storage of one or more digital assets, according to one or more embodiments described herein;

FIG. 4 depicts an exemplary magnetic storage device for the storage of one of more digital assets, according to one or more embodiments described herein;

FIG. 5 depicts a typical computer system for the storage of one or more digital assets, according to one or more embodiments described herein;

FIG. 6 depicts a typical method for copying one or more digital assets to a storage apparatus, according to one or more embodiments described herein; and

FIG. 7 depicts a typical logic flow diagram for providing a method for storing one or more digital assets using the storage apparatus depicted in FIG. 1, according to one or more embodiments described herein.

### DETAILED DESCRIPTION

A detailed description will now be provided. Each of the appended claims defines a separate invention, which for infringement purposes is recognized as including equivalents to the various elements or limitations specified in the claims. Depending on the context, all references below to the “invention” may in some cases refer to certain specific embodiments only. In other cases it will be recognized that references to the “invention” will refer to subject matter recited in one or more, but not necessarily all, of the claims. Each of the inventions will now be described in greater detail below, including specific embodiments, versions and examples, but the inventions are not limited to these embodiments, versions or examples, which are included to enable a person having ordinary skill in the art to make and use the inventions, when the information in this patent is combined with available information and technology.

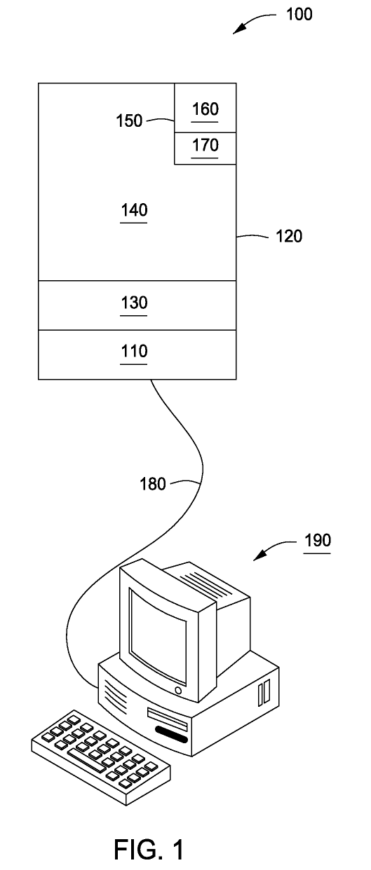

FIG. 1 depicts a typical storage apparatus 100 for one or more digital assets, according to one or more embodiments. In one or more embodiments, the storage apparatus 100 can include one or more interfaces 110, one or more storage areas 120, and one or more unique device identifiers 130. In one or more embodiments, the one or more storage areas 120 can be equally or unequally apportioned into one or more computer readable/writable data storage areas 140, and one or more computer readable data storage areas 150. In one or more embodiments, the one or more computer readable data storage areas 150 can be equally or unequally apportioned into one or more computer readable instruction sets 160 and, optionally, one or more unique instruction set identifiers 170.

In one or more embodiments, the one or more interfaces 110 can be used to communicatively couple a computer system 190 to the storage apparatus 100 via one or more conductors 180. The communicative coupling of the computer 190 to the storage apparatus 100 via the one or more interfaces 110 can provide read/write access to the one or more storage areas 120 disposed in, on, or about the storage apparatus 100. The communicative coupling of the computer 190 to the one or more storage areas 120 can permit the computer 190 to read and/or write data to the one or more one or more computer readable/writable data storage areas 140 and/or read one or more computer readable instruction sets 160 from the one or more computer readable data storage areas 150.

The one or more interfaces 110 can include any system, device, or combination of systems and devices, used by the computer 190 to access all or a portion of the computer readable/writeable storage area 120 and/or computer readable instruction set 160. In one or more embodiments, the interface 110 can include one or more optical storage media interfaces, one or more semiconductor storage media interfaces, one or more magnetic storage media interfaces, or one or more bridge circuits linking two different media interfaces, for example linking an eSATA or IDE interface to a USB or Firewire interface. In one or more embodiments, the interface 110 can be partially or completely disposed in, on, or about the computer 160. In one or more embodiments, the interface 110 can include one or more chipsets disposed in, on, or about the computer 190. In one or more embodiments, the interface 110 can be disposed partially or completely in, on, or about an external device, for example an external optical drive or an external magnetic storage device.

In one or more embodiments, the one or more interfaces can include one or more universal serial bus (USB 1.0/2.0) connectors, one or more internal serial ATA (SATA) interfaces, one or more external serial ATA (eSATA) interfaces, one or more I.E.E.E. 1394 (Firewire 400/800) interfaces, one or more Integrated Drive Electronics (IDE) interfaces, one or more Small Computer Serial Interfaces (SCSI) interfaces, or the like. In one or more embodiments, the interface 110 can include one or more optical media interfaces, for example a compact disc (CD) drive, a digital versatile disc (DVD) drive, a Blu-ray® drive, or any other form of detachable optical-based data storage interface known in the art. In one or more embodiments, the interface 110 can include one or more magnetic media interfaces, for example an eSATA hard drive; a USB hard drive; or any other form of detachable magnetic-based data storage interface known in the art. In one or more embodiments, the interface 110 can include one or more semiconductor media interfaces, for example a USB hard drive; a USB memory stick; secure digital (“SD”) cards; a Multi-Media (“MMC”) card; a high-density secure digital (“HDSD”) card; a compact flash (“CF”) card; an Extreme Digital (“xD”) card; or any other form of detachable semiconductor-based data storage interface known in the art. In one or more embodiments, the interface 110 can include one or more bridge circuits communicatively coupling one or more IDE, SATA or eSATA compliant magnetic media with an I.E.E.E. 1394 (“Firewire®”) port, a USB port, or the like, disposed in, on, or about the storage device 100 or computer 190.

In one or more specific embodiments, the interface 110 can include one or more optical media interfaces, for example a CD or DVD drive disposed internal or external to the computer 190. In one or more specific embodiments, the interface 110 can include one or more semiconductor media interfaces, for example an SD or SDHC interface disposed internal or external to the computer 190. In one or more specific embodiments, the interface 110 can include one or more magnetic storage media interfaces, for example one or more eSATA interfaces disposed internal or external to the computer 190. In one or more specific embodiments, the interface 110 can include one or more bridge circuits, disposed in, on, or about the storage device 100 or computer 190, communicatively coupling one or more eSATA compliant magnetic media (i.e., “hard drive”) to a USB port.

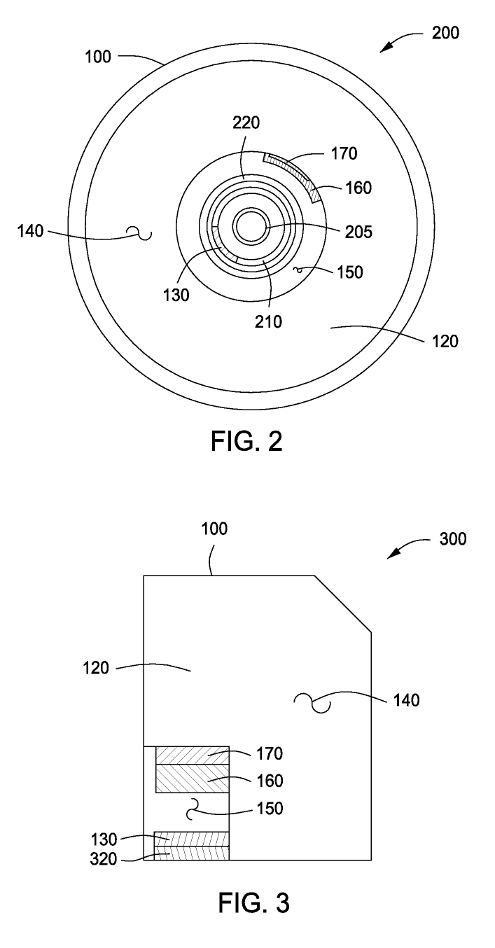

FIG. 2 depicts an exemplary optical storage medium 200 for the storage of one or more digital assets, according to one or more embodiments. In one or more embodiments, the storage apparatus 100 can include, but is not limited to an optical storage medium 200. In one or more embodiments, the optical storage medium 200 can include a hub 205 having one or more wobble rings 210 disposed concentrically thereabout. The one or more storage areas 120 disposed in, on, or about the optical storage medium 200 can be equally or unequally apportioned into one or more computer readable/writable data storage areas 140, and one or more computer readable data storage areas 150. In one or more embodiments, the one or more computer readable data storage areas 150 disposed in, on, or about the optical storage medium 200 can be equally or unequally apportioned into one or more computer readable instruction sets 160 and, optionally, one or more unique instruction set identifiers 170.

In one or more embodiments, one or more computer readable instruction sets 160 and one or more unique instruction set identifiers 170 can be disposed partially or completely within the one or more computer readable data storage areas 150. In one or more embodiments, the one or more computer readable instruction sets 160 can include, but are not limited to, one or more executable files. In one or more specific embodiments, the one or more computer readable instruction sets 160 can include one or more data back-up or archiving programs useful for backing up or archiving all or a portion of the data from the computer 190 to the optical storage media 200 communicatively coupled to the computer 190. In one or more embodiments, the one or more unique instruction set identifiers 170 can be encrypted, encoded or otherwise protected from detection, discovery, decoding and/or decryption using any means of digital data protection known to the art.

In one or more embodiments, one or more unique device identifiers 130 can be disposed in, on, or about the optical storage medium 200. In one or more embodiments, the one or more unique device identifiers 130 can be disposed in, on, or about the wobble ring 210 of the optical storage medium 200. Although not shown in FIG. 2, in one or more embodiments, the one or more unique device identifiers 130 can be disposed in, on, or about the data storage area 120. In one or more embodiments, the one or more unique device identifiers 130 can be encrypted, encoded or otherwise protected from detection and/or discovery using any means of data protection known to the art. In one or more embodiments, the one or more unique device identifiers 130 can provide a means for uniquely identifying a specific piece of optical storage media 200 (i.e., no two pieces of optical storage media 200 share the same unique device identifiers 130).

In one or more embodiments, the optical storage medium 200 can include any light or laser sensitive storage medium suitable for the storage of digital data. In one or more embodiments, the optical storage medium 200 can include, but is not limited to, a single-layer compact disc (“CD”); a multi-layer CD; a single-layer digital versatile disk (“DVD”); a multi-layer DVD; a single-layer Blu-ray® disc; or a multi-layer Blu-ray® DVD.

In one or more embodiments, the optical storage medium 200 can be a CD. The CD 200 can have any diameter, for example a standard CD having a diameter of about 12 cm (4.72 in), or a mini-CD having a diameter of about 8 cm (3.15 in). The CD 200 can include one or more wobble rings 210 disposed concentrically about the hub 205 of the optical storage medium 200. The CD 200 can include one or more introductory tracks 220 containing digital data. In one or more embodiments, an 12 cm diameter, standard, CD 200 can have a storage capacity of from about 300 megabytes (“MB”) to about 1 gigabyte (“GB”); about 500 MB to about 800 MB; or about 650 MB to about 700 MB. In one or more embodiments, an 8 cm diameter, mini-CD 200 can have a storage capacity of from about 100 megabytes (“MB”) to about 500 MB; about 150 MB to about 350 MB; or about 185 MB to about 210 MB.

In one or more embodiments, the optical storage medium 200 can be a DVD. The DVD 200 can have any diameter, for example a standard DVD having a diameter of about 12 cm (4.72 in.), or a mini-DVD having a diameter of about 8 cm (3.15 in.). The DVD 200 can include one or more wobble rings 210 disposed concentrically about the hub 205 of the optical storage medium 200. The DVD 200 can include one or more introductory tracks 220 containing digital data. In one or more embodiments, a 12 cm diameter, standard, DVD 200 can have a storage capacity of from about 3 GB to about 20 gigabytes; about 4 GB to about 18 GB; or about 4.7 GB to about 15.9 GB. In one or more embodiments, an 8 cm diameter, mini, DVD 200 can have a storage capacity of from about 1 GB to about 7 gigabytes; about 1.25 GB to about 5.5 GB; or about 1.46 GB to about 4.95 GB.

In one or more embodiments, the optical storage medium 200 can be a Blu-ray® disc. The Blu-ray® disc 200 can have any diameter, for example a standard Blu-ray® disc having a diameter of about 12 cm (4.72 in.). The Blu-ray® disc 200 can include one or more wobble rings 210 disposed concentrically about the hub 205 of the optical storage medium 200. The Blu-ray® disc 200 can include one or more introductory tracks 220 containing digital data. In one or more embodiments, an 12 cm diameter, standard, Blu-ray® disc 200 can have a storage capacity of from about 20 GB to about 100 gigabytes; about 22.5 GB to about 75 GB; or about 25 GB to about 50 GB. In one or more embodiments, an 8 cm diameter, mini, Blu-ray® disc 100 can have a storage capacity of from about 5 GB to about 20 gigabytes; about 6.5 GB to about 17.5 GB; or about 7.8 GB to about 15.6 GB.

FIG. 3 depicts an exemplary semiconductor storage medium 300 for the storage of one or more digital assets, according to one or more embodiments. In one or more embodiments, the storage apparatus 100 can include, but is not limited to a semiconductor storage medium 300. In one or more embodiments, the semiconductor storage medium 300 can include any electrically susceptible storage medium suitable for the storage of digital data and/or files. In one or more embodiments, the semiconductor storage medium 300 can be equally or unequally apportioned into one or more computer readable/writable data storage areas 140, and one or more computer readable data storage areas 150. In one or more embodiments, the one or more computer readable data storage areas 150 disposed in, on, or about the semiconductor storage medium 300 can be equally or unequally apportioned into one or more computer readable instruction sets 160 and, optionally, one or more unique instruction set identifiers 170.

In one or more embodiments, one or more computer readable instruction sets 160 and one or more unique instruction set identifiers 170 can be partially or completely disposed in, on, or about the one or more computer readable data storage areas 150. In one or more embodiments, the one or more computer readable instruction sets 160 can include, but are not limited to, one or more executable programs. In one or more specific embodiments, the one or more computer readable instruction sets 160 can include one or more data back-up programs useful for backing up all or a portion of the data from the computer 190 to the semiconductor storage media 300 when the semiconductor storage media 300 is communicatively coupled to the computer 190. In one or more embodiments, the one or more unique instruction set identifiers 170 can be encrypted, encoded or otherwise protected from detection, discovery, decoding and/or decryption using any means of digital data protection known to the art.

In one or more embodiments, one or more unique device identifiers 130 can be disposed in, on, or about the semiconductor storage medium 300. In one or more specific embodiments, one or more unique device identifiers 130 can be disposed in, on, or about a specific non-volatile, read only portion of the semiconductor storage medium 300. Although not shown in FIG. 3, in one or more embodiments, the one or more unique device identifiers 130 can be disposed in, on, or about the data storage area 120. In one or more embodiments, the one or more unique device identifiers 130 can be encrypted, encoded or otherwise protected from detection and/or discovery using any means of data protection known to the art. In one or more embodiments, the one or more unique device identifiers 130 can provide a means for uniquely identifying a specific piece of semiconductor storage medium 300 (i.e., no two pieces of semiconductor storage media 300 can have identical unique device identifiers 130).

In one or more embodiments, the semiconductor storage medium 300 can include any semiconductor storage medium suitable for the storage of one or more digital assets. In one or more embodiments, the semiconductor storage medium 300 can include one or more solid state drives (SSDs), for example an eSATA compliant SSD. In one or more embodiments, the semiconductor storage medium 300 can include, but is not limited to a USB memory stick; secure digital (“SD”) cards, including standard, mini, and micro SD cards; a Multi-Media (“MMC”) card; a high-capacity secure digital (“SDHC”) card; a compact flash (“CF”) card; an Extreme Digital (“xD”) card; a memory stick; or any other form of removable and/or detachable semiconductor-based data storage media known in the art. The semiconductor storage medium 300 can have a storage capacity of from about 1 MB to about 100 terabytes (“TB”); about 2 MB to about 50 TB; or about 4 MB to about 20 TB.

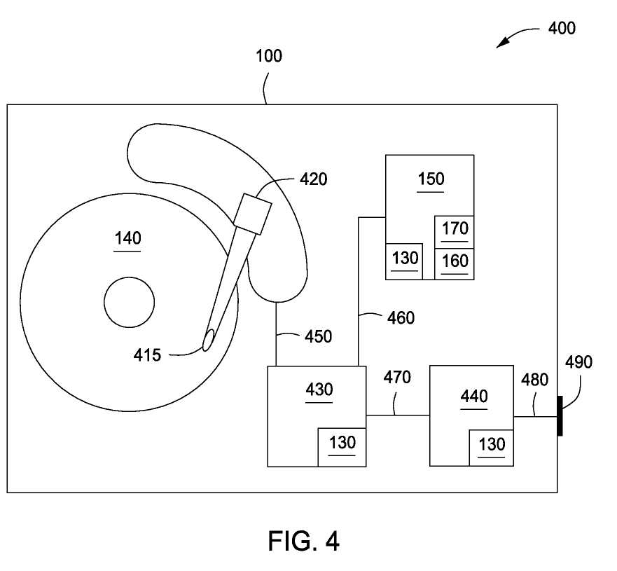

FIG. 4 depicts an exemplary magnetic storage device 400 for the storage of one or more digital assets, according to one or more embodiments. In one or more embodiments, the storage apparatus 100 can include, but is not limited to a magnetic storage medium 400. In one or more embodiments, the magnetic storage device 400 can include any system, device, or combination of systems and device capable of permanently or temporarily storing digital data and/or files on a magnetically susceptible storage medium. In one or more specific embodiments, the magnetic storage device 400 can include one or more rotating magnetic storage media, for example a hard disk drive. In one or more embodiments, the magnetic storage device 400 can include one or more computer readable/writable data storage areas 140, read/write heads 415 disposed in, on, or about one or more read/write arms 420, controllers 430, bridge circuits 440, and one or more conduits communicatively coupling all or a portion of the aforementioned components (three conduits are depicted in FIG. 4, 450, 460, and 470). In one or more embodiments, magnetic storage device 400 can include one or more computer readable data storage areas 150. The magnetic storage device 400 can also include one or more conduits 480 communicatively coupling the magnetic storage medium to one or more external devices, for example one or more computers 190 (not depicted in FIG. 4).

In one or more embodiments, the computer readable/writable data storage areas 410 can include, but is not limited to one or more rotating, hard drive platters. Any number of hard drive platters can be used to provide the computer readable/writable data storage areas 140. In one or more embodiments, 2 or more, 4 or more, 8 or more, or 10 or more platters can be “stacked” or otherwise proximately arranged to provide all or a portion of the computer readable/writable data storage areas 140. In one or more embodiments, the computer readable/writable data storage areas 140 can have a storage capacity of from about 1 megabyte (“MB”) to about 100 terabytes (“TB”); about 2 MB to about 50 TB; or about 4 MB to about 20 TB.

In one or more embodiments, data can be written to or read from the computer readable/writable data storage areas 140 using one or more read/write heads 415 disposed in on, or about one or more arms 420. In one or more embodiments, the one or more read/write heads and the one or more computer readable/writable data storage areas 140 can be interleaved, with each computer readable/writable data storage areas 140 platter having one or more read/write heads 415 and one or more arms 420 disposed proximate thereto. In one or more embodiments, the position of the read/write head 415 and the data transferred to or from the computer readable/writable data storage areas 140 can be controlled using one or more controllers 430.

The one or more controllers 430 can include one or more circuits, integrated circuits, chipsets, or any combination thereof suitable for converting or otherwise transforming one or more electrical signals transmitted or otherwise provided by the one or more bridge circuits 440 to magnetic data stored on the computer readable/writable data storage areas 140. The one or more controllers 430 can include one or more circuits, integrated circuits, chipsets, or any combination thereof suitable for converting all or a portion of the magnetic data stored on the computer readable/writable data storage areas 140 into one or more electrical signals received by the one or more bridge circuits 440. In one or more embodiments, the controller 430 can include one or more sets of read-only code in the form of software and/or firmware for controlling the transfer of data between the magnetic storage device 400 and the computer 190. In one or more embodiments, the one or more controllers 430 can be communicatively coupled to the one or more computer readable data storage areas 150 using one or more conduits 460. In one or more embodiments, the one or more controllers 430 can be communicatively coupled to the one or more bridge circuits 440 via one or more conduits 470.

In one or more embodiments, one or more unique device identifiers 130 can be disposed in, on, or about the one or more controllers 430. In one or more embodiments, the one or more unique device identifiers 130 disposed in, on, or about the one or more controllers 430 can provide a means for uniquely identifying a specific magnetic storage device 400 (i.e., no two magnetic storage devices 400 can have identical unique device identifiers 130). In one or more embodiments, the one or more unique device identifiers 130 can include, but are not limited to one or more vendor unique commands provided by the one or more controllers 430. In one or more embodiments, the one or more unique device identifiers 130 can be transmitted or otherwise communicated to the computer 190 in conjunction with the magnetic storage device 400 inquiry data provided when coupling the magnetic storage device 400 to the computer 190.

The one or more bridge circuits 440 can include one or more circuits, integrated circuits, chipsets, or any combination thereof suitable for converting, translating, or otherwise transforming data between the magnetic storage device 400 interface, for example IDE interface or SATA interface and the computer 190 interface, for example a USB, Firewire or eSATA interface disposed in, on, or about the computer 190. In one or more embodiments, the one or more bridge circuits 440 can include one or more sets of read-only code in the form of software and/or firmware for controlling the conversion, translation and/or transfer of data between the magnetic storage device 400 and the computer 190. In one or more embodiments, the one or more bridge circuits 440 can be communicatively coupled to the one or more controllers 430 using one or more conduits 470. In one or more embodiments, the one or more bridge circuits can be bi-directionally, communicatively, coupled to one or more interfaces 490 via one or more conduits 480. In one or more embodiments, the one or more interfaces can include, but are not limited to, one or more USB 1.0/2.0 interfaces; one or more IEEE 1394 400/800 Firewire Interfaces; one or more eSATA interfaces; one or more SATA interfaces; one or more IDE interfaces; or any combination thereof.

In one or more embodiments, one or more unique device identifiers 130 can be disposed in, on, or about the one or more bridge circuits 440. In one or more embodiments, the one or more unique device identifiers 130 disposed in, on, or about the one or more bridge circuits 440 can provide a means for uniquely identifying a specific magnetic storage device 400 (i.e., no two magnetic storage devices 400 can have identical unique device identifiers 130).

In one or more specific embodiments, the one or more unique device identifiers 130 disposed in, on, or about the one or more bridge circuits 440 can include, but are not limited to one or more unique product identifiers, for example one or more unique USB Vendor and/or Product ID (“VID/PID”). In one or more embodiments, the one or more computer readable instruction sets 160 can use all or a portion of the USB VID/PID to validate or otherwise authorize the execution of all or a portion of the one or more computer readable instruction sets 160 disposed in, on, or about the magnetic storage device 400. In one or more embodiments, the one or more unique device identifiers 130 can be transmitted, conveyed, or otherwise communicated to the computer 190 in conjunction with the magnetic storage device 400 inquiry data provided when communicatively coupling the magnetic storage device 400 to the computer 190.

In one or more specific embodiments, the one or more unique device identifiers 130 disposed in, on, or about the one or more bridge circuits 440 can include one or more suffixes appended to, for example, the bulk-only data interface descriptor string, and/or the USB device descriptor string. In one or more embodiments, the one or more computer readable instruction sets 160 can use all or a portion of the one or more suffixes to validate or otherwise authorize the execution of all or a portion of the one or more computer readable instruction sets 160 disposed in, on, or about the magnetic storage device 400. In one or more embodiments, the one or more unique device identifiers 130 can be transmitted, conveyed, or otherwise communicated to the computer 190 in conjunction with the magnetic storage device 400 inquiry data provided when communicatively coupling the magnetic storage device 400 to the computer 190.

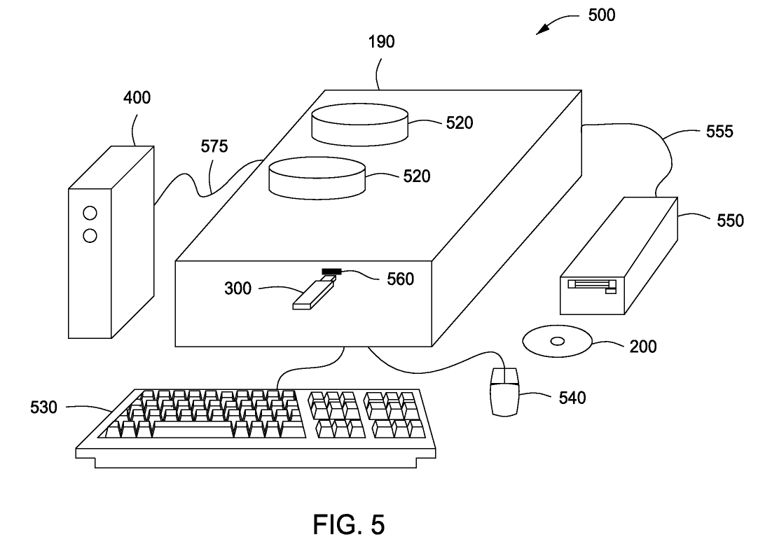

FIG. 5 depicts a typical computer system 500 for the storage of one or more digital assets, according to one or more embodiments. In one or more embodiments, the computer system 500 can include one or more computers 190, having one or more storage devices 520 disposed in, on, or about the computer system 500 (although two internal storage devices 520 are depicted in FIG. 5, any number of storage devices can be disposed internal or external to the computer system 500), one or more input devices (a keyboard 530 and a mouse 540 are depicted in FIG. 5), one or more optical drives 550, and one or more semiconductor drives 560. In one or more embodiments, one or more magnetic storage devices 400 can be bi-directionally, communicatively coupled to the computer 190. In one or more embodiments, all or a portion of the one or more optical drives 550 can be disposed internal or external to the one or more one or more computers 190. In one or more embodiments, all or a portion of the one or more semiconductor drives 560 can be disposed internal or external to the one or more computers 190. In one or more embodiments, all or a portion of the one or more magnetic storage devices 400 can be disposed internal or external to the one or more computers 190.

As used herein, the terms “computer,” “host computer,” and “computer system” can refer to any system, device, or any combination of systems and/or devices capable of reading and executing all or a portion of the computer readable instruction sets 160 stored in the computer readable data storage areas 150 of the storage apparatus 100. Such systems and/or devices can include, but are not limited to, personal, portable, laptop, mainframe, blade and thin-client computers; personal digital or data assistants (collectively “PDAs”); telephonic devices such as cellular telephones; handheld computing devices; gaming consoles; and the like.

In one or more embodiments, an optical storage medium 200 can be introduced to the computer 190 via the one or more optical drives 550. In one or more embodiments, the optical storage medium 200 can be introduced to the one or more external optical drives 550, communicatively coupled to the computer 190 via one or more conductors 555. In one or more embodiments, all or a portion of the digital files and/or data disposed in, on, or about the one or more storage devices 520 can be copied, duplicated, transferred, or otherwise transmitted to the one or more computer readable/writable data storage areas 140 disposed in, on, or about the optical storage medium 200.

In one or more embodiments, a semiconductor storage medium 300 can be introduced to the computer 190. In one or more embodiments, the semiconductor storage medium 300 can be communicatively coupled to the computer 190 via one or more semiconductor interfaces 560, for example via a USB port, a PCI slot, a CF interface, an SD interface, or the like. In one or more embodiments, all or a portion of the digital files and/or data disposed in, on, or about the one or more storage devices 520 can be copied, duplicated, transferred, or otherwise transmitted to the one or more computer readable/writable data storage areas 140 disposed in, on, or about the semiconductor storage medium 300.

In one or more embodiments, one or more magnetic storage devices 400 can be communicatively coupled to the computer 190 via one or more conductors 575. In one or more embodiments, the one or more magnetic storage devices 400 can be communicatively coupled to the computer 190 using one or more interfaces disposed in, on, or about the computer 190, for example one or more USB 1.0/2.0 interfaces, one or more IEEE 1394 Firewire 400/800 interfaces, or one or more SATA/eSATA interfaces. In one or more embodiments, all or a portion of the digital files disposed in, on, or about the one or more storage devices 520 can be copied, duplicated, transferred, or otherwise transmitted to the one or more computer readable/writable data storage areas 140 disposed in, on, or about the magnetic storage device 400.

In one or more embodiments, the one or more storage devices 520 can include any system, device, or combination of systems and/or devices suitable for the storage of digital data and/or files. In one or more embodiments, the digital data and/or files stored on the one or more storage devices 520 can include, but are not limited to: still image files, for example digital photographs in JPEG, TIFF, RAW, PNG, GIF, BMP, PPM, PGM, PBM, or PNM formats; video files, for example videos in MPEG, WMV, AVI, or MOV formats; audio files, for example audio files in AAC, WAV, MP3, MP4, or WMV formats; executable files; system files; or the like. In one or more embodiments, the one or more storage devices 520 can include, but are not limited to one or more solid state drives (SSDs), hard disk drives (HDDs), or any combination thereof.

In one or more embodiments, a computer user or programmer can instruct or otherwise interact with the computer system 500 using one or more input devices, for example a keyboard 530 or mouse 540. In one or more embodiments, computer user or programmer input can be provided in response to one or more prompts generated as the computer 190 executes or otherwise compiles or interprets all or a portion of the one or more computer readable instruction sets 160. In one or more embodiments, user or programmer input can be provided before or during the transmission of data between the one or more storage devices 520 and the storage apparatus 100. In one or more embodiments, the user or programmer of the computer system 500 can provide one or more selection criteria used to select or otherwise identify target files for copying, duplication, transferral, and/or transmission from the computer system 500 to the storage apparatus 100. In one or more specific embodiments, the one or more user or programmer defined selection criteria can include, but are not limited to, the specification of one or more file types, for example image, video, and/or audio files; location of the source files; one or more inherent file characteristics, for example, file size, creation date, modification date; or any combination thereof.

After copying, duplicating, transferring, and/or transmitting the desired files to the storage apparatus 100, the user or programmer can detach, disengage, detach or otherwise remove the storage apparatus 100, from the computer 190. By disengaging, detaching or otherwise removing the storage apparatus 100, from the computer 190, the user can store, archive or back-up the files contained thereon in a location remote from the computer 190. Providing a remote data redundancy, a data back-up, or a data archive, in this manner can permit the recovery of all or a portion of the data contained on the one or more storage devices 520 using all or a portion of the stored, backed-up, or archived files contained on the storage apparatus 100.

As used herein, the term “data back-up” and “data archive” can refer to the copying or duplication of one or more digital files from the computer system to an second, archival, storage medium to prevent loss, damage, or corruption of the data in the event of a partial or complete failure of one or more devices forming the computer system. In one or more embodiments, the digital files can be compressed on the archival storage medium to conserve space and permit the storage of large quantities of data on the archival storage medium. In one or more embodiments, the digital files can be encrypted and or encoded on the archival storage medium to prevent the restoration of the files from the archival storage medium to an unauthorized or unintended computer system. In one or more embodiments, the digital files can be password protected on the archival storage medium to prevent unauthorized access to all or a portion of the files contained on the archival storage medium.

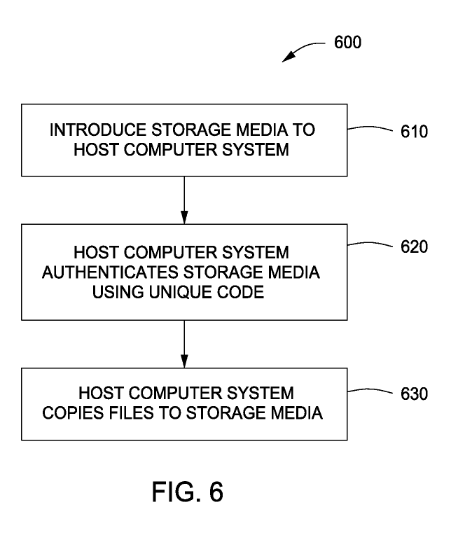

FIG. 6 depicts a typical method 600 for copying one or more digital assets to a storage apparatus 100, according to one or more embodiments. In one or more embodiments, in step 610, one or more storage apparatus 100 can be introduced or otherwise communicatively coupled to the computer 190. In one or more embodiments, the storage apparatus 100 can contain one or more storage areas equally or unequally sub-divided into one or more computer readable/writable data storage areas 140 and one or more computer readable data storage areas 150.

In one or more embodiments, one or more unique instruction set identifiers 170 can be disposed in, on, or about the one or more computer readable data storage areas 150. In one or more embodiments, in step 620, the computer 190 can authenticate the storage apparatus 100 and/or the one or more computer readable instruction sets 160 using any combination of all or a portion of the one or more unique storage device identifiers 130 and/or the one or more unique instruction set identifiers 170 disposed in, on, or about the storage apparatus 100.

After authenticating the storage apparatus 100 and/or all or a portion of the one or more computer readable instruction sets 160, in step 630 the computer 190 can copy, back-up, archive or otherwise duplicate all or a portion of the files and/or data contained on the one or more storage devices 520 to all or a portion of the one or more computer readable/writable data storage areas 140 of the storage apparatus 100.

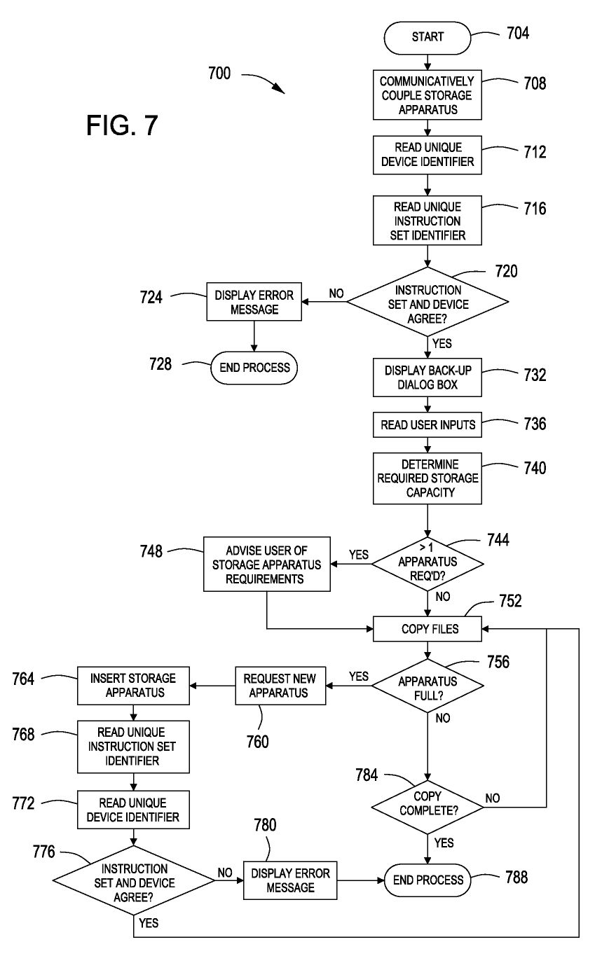

FIG. 7 depicts a typical logic flow diagram 700 providing a method for the storage of one or more digital assets using a storage apparatus 100 according to one or more embodiments. The method 700 begins at step 708 with the introduction of the storage apparatus 100 to the appropriate interface, e.g. the magnetic storage device 400, the optical drive 550, and/or semiconductor interface 560 disposed in, on, or about the computer 190. In one or more embodiments, the computer 190 can begin executing or otherwise compiling all or a portion of the computer readable instruction set 160 upon the introduction of the storage apparatus 100 to the computer 190. In one or more embodiments, the computer readable instruction set 160 can have one or more auto-executable files, for example one or more “autorun.ini” files, disposed in, on, or about the one or more read-only portions 150 of the storage apparatus 100.

In one or more embodiments, in step 712, all or a portion of the computer readable instruction set 160 can allow or otherwise authorize the computer 190 to read all or a portion of the one or more one or more unique instruction set identifiers 170 disposed in, on, or about the storage apparatus 100. In one or more embodiments, in step 716, the computer readable instruction set 160 can allow or otherwise authorize the computer 190 to read all or a portion of the one or more unique device identifiers 130 disposed in, on, or about the storage apparatus 100.

In step 716, the computer 190 can confirm the authenticity of all or a portion of the one or more computer readable instruction sets 160 and/or the storage apparatus 100 by comparing the one or more unique instruction set identifiers 170 with the one or more unique device identifiers 130. Other, equally effective, authentication methods using either the unique instruction set identifier 170 or the unique device identifier 130, or both the unique instruction set identifier 170 and the unique device identifier 130 can be readily implemented by one of ordinary skill in the art, and should thus be considered part of this disclosure. If the one or more unique instruction set identifiers 170 fail to authenticate and/or authorize the execution of the one or more computer readable instruction sets 160, the computer 190 can provide the user or programmer with one or more error messages in step 724 prior to terminating execution of the computer readable instruction set 160 in step 728.

If the one or more unique instruction set identifiers 170 matches, authenticates, validates, or otherwise authorizes the execution of one or more computer readable instruction sets 160, the computer 190 can execute all or a portion of the one or more computer readable instruction sets 160. In one or more embodiments, in step 732, the execution of the one or more computer readable instruction sets 160 can generate a back-up dialog box in which the user or programmer can specify one or more source file and/or data selection criteria, for example file location, file type, file creation date, file modification date, file size, and the like. In one or more embodiments, the user or programmer can respond, in step 736, providing one or more file selection criteria inputs to the computer 190.

In one or more embodiments, in step 740, the computer 190 can scan or otherwise read the one or more files and/or data disposed in, on, or about the one or more storage devices 520, selecting one or more files and/or data based upon the user or programmer defined selection criteria provided in step 732. In one or more embodiments, the computer 190 can calculate the required storage capacity for the files and/or data selected for storage, back-up, and/or archive based upon the user or programmer provided file selection criteria provided in step 732. In one or more embodiments, in step 740, the computer 190 can scan the storage apparatus 100 to determine whether the available storage capacity of the one or more computer readable/writable data storage areas 140 of the storage apparatus 100 can accommodate user or programmer selected files and/or data. If the computer 190 determines the required storage capacity for the files and/or data exceeds the available storage capacity of the storage apparatus 100, the computer 190 can advise the user or programmer of the storage media requirements in step 748. All or a portion of the selected files and/or data can be copied from the one or more storage devices 520 to the one or more computer readable/writable data storage areas 140 of the storage apparatus 100 in step 752.

While copying, backing-up, or archiving the user or programmer selected files to the one or more computer readable/writable data storage areas 140 of the storage apparatus 100 in step 752, the computer 190 can determine whether the available storage capacity of the one or more computer readable/writable data storage areas 140 has been exhausted in step 756. If the available storage capacity of the one or more computer readable/writable data storage areas 140 has been exhausted, in step 760 the computer 190 can request the insertion or introduction of a new storage apparatus 100 to the computer 190 by the user or programmer. After inserting or introducing the new storage apparatus 100 in step 764, the computer 190 can, in step 768, read the one or more unique instruction set identifiers 170 disposed in, on, or about the storage apparatus 100. In step 772, the computer 190 can read the one or more unique device identifiers 130 disposed in, on, or about the storage apparatus 100. If all or a portion of the one or more unique instruction set identifiers 170 does not match, authorize, or otherwise authenticate all or a portion of the one or more unique device identifiers 130, the computer 190 can provide the user or programmer with one or more error messages in step 780 prior to terminating execution of the computer readable instruction set 160 in step 788.

If the computer 190 determines in step 756 that available storage capacity remains in the one or more computer readable/writable data storage areas 140, or if the computer 190 determines that the user has inserted a new storage apparatus 100 in step 764, the computer 190 can continue copying, backing-up, or archiving the user or programmer selected files and/or data to the one or more computer readable/writable data storage areas 140 of the storage apparatus 100. In one or more embodiments, the computer 190 can periodically check or otherwise determine whether all of the user or programmer selected files have been copied in step 784. If the all of the user or programmer selected files have not been copied, the computer 190 can: (i) continue to copy the user selected files in step 752, (ii) determine whether the one or more computer readable/writable data storage areas 140 of the storage apparatus 100 are full in step 756, and (iii) determine whether all of the user or programmer selected files have been copied in step 784. In one or more embodiments, after all the user or programmer selected files have been copied to the storage apparatus 100, the process can terminate in step 788.

Certain embodiments and features have been described using a set of numerical upper limits and a set of numerical lower limits. It should be appreciated that ranges from any lower limit to any upper limit are contemplated unless otherwise indicated. Certain lower limits, upper limits and ranges appear in one or more claims below. All numerical values are “about” or “approximately” the indicated value, and take into account experimental error and variations that would be expected by a person having ordinary skill in the art.

Various terms have been defined above. To the extent a term used in a claim is not defined above, it should be given the broadest definition persons in the pertinent art have given that term as reflected in at least one printed publication or issued patent. Furthermore, all patents, test procedures, and other documents cited in this application are fully incorporated by reference to the extent such disclosure is not inconsistent with this application and for all jurisdictions in which such incorporation is permitted.

While the foregoing is directed to embodiments of the present invention, other and further embodiments of the invention may be devised without departing from the basic scope thereof, and the scope thereof is determined by the claims that follow.

What is claimed is:

1. A storage apparatus, comprising:
one or more storage devices;
one or more unique device identifiers identifying the storage device;
one or more computer readable and writeable data storage areas;
one or more computer readable data storage areas; and
one or more computer readable instruction sets, wherein the execution of all or a portion of the one or more computer readable instruction sets is contingent upon the successful authentication of all or a portion of the one or more device identifiers.

2. The storage apparatus of claim 1, wherein the one or more storage devices comprises an optical storage media having the one or more device identifiers disposed in, on, or about a computer readable data storage area of the optical storage media.

3. The storage apparatus of claim 1, wherein the one or more storage devices comprises a semiconductor storage media having the one or more device identifiers disposed in, on, or about a computer readable data storage area of the semiconductor storage media.

4. The storage apparatus of claim 1, wherein the one or more storage devices comprises one or more magnetic storage devices having the one or more device identifiers disposed in, on, or about one or more computer readable data storage areas communicatively coupled to the one or more magnetic storage devices.

5. The storage apparatus of claim 1, wherein the one or more computer readable instruction sets comprise back-up software for the duplication of all or a portion of data from one or more storage devices disposed in, on, or about a computer, to the one or more computer readable and writeable data storage areas disposed in, on, or about the storage apparatus.

6. The storage apparatus of claim 5, wherein the data comprises one or more image files, one or more video files, one or more audio files, or any combination thereof.

7. The storage apparatus of claim 1, wherein the one or more one or more unique device identifiers are permanently disposed in, on, or about the one or more computer readable data storage areas disposed in, on, or about the storage apparatus.

8. The storage apparatus of claim 1, wherein the storage apparatus comprises an optical storage medium and wherein the one or more unique device identifiers are permanently disposed in, on, or about a wobble ring disposed in, on, or about the optical storage medium.

9. The apparatus of claim 8, wherein the optical storage medium is selected from a group consisting of a write-once digital versatile disk (“DVD”), a rewritable DVD (“DVD-RW”), a write-once compact disc (“CD”), and a rewritable CD (“CD-RW”).

10. The storage apparatus of claim 1, wherein the storage apparatus comprises a semiconductor storage medium selected from a group consisting of a compact flash (“CF”) device, a secure digital (“SD”) device, a high-density secure digital (“HDSD”) device, a memory stick device, a mini-SD device, and a solid state disk (“SSD”) device.

11. The storage apparatus of claim 1, wherein one or more unique instruction set identifiers are disposed in, on, or about the one or more computer readable data storage areas disposed in, on, or about the storage apparatus.

12. A method for storing data, comprising:
communicatively coupling to a computer, a storage apparatus comprising:
one or more storage devices;
one or more unique device identifiers identifying the storage device;
one or more computer readable and writeable data storage areas;
one or more computer readable data storage areas; and
one or more computer readable instruction sets;
reading the one or more one or more unique device identifiers disposed in, on, or about the storage apparatus;
executing all or a portion of the one or more computer readable instruction sets contingent upon the successful authentication of all or a portion of the one or more unique device identifiers; and
transferring data from the one or more storage devices disposed in, on, or about the computer to all or a portion of the one or more computer readable and writeable data storage areas of the storage apparatus.

13. The method of claim 12, wherein the data can be written serially or sequentially from the one or more storage devices disposed in, on, or about a computer to a plurality of storage apparatuses when the required storage capacity for the data exceeds the available storage capacity of a single storage apparatus.

14. The method of claim 12, further comprising:
disposing one or more unique instruction set identifiers in, on, or about the storage apparatus;
reading the one or more unique instruction set identifiers disposed in, on, or about the storage apparatus; and
validating or authenticating all or a portion of the computer readable instruction set using all or a portion of the one or more unique instruction set identifiers.

15. A system for the storage of data comprising:
a means for disposing in, on, or about a computer, a storage apparatus comprising;
one or more storage devices;
one or more unique device identifiers identifying the storage device;
one or more computer readable and writeable data storage areas;
one or more computer readable data storage areas; and
one or more computer readable instruction sets, wherein the execution of all or a portion of the one or more computer readable instruction sets is contingent upon the successful authentication of all or a portion of the one or more unique device identifiers;
a means for reading the one or more unique device identifiers disposed in, on, or about the storage apparatus;
a means for authenticating the storage apparatus using the one or more unique device identifiers; and
a means for transferring data from the computer to all or a portion of the one or more computer readable and writeable data storage areas.
